(19) United States
(12) Patent Application Publication
(10) Pub. No.: US 2009/0201669 A1
(43) Pub. Date: Aug. 13, 2009

(54) BACKLIGHT DEVICE, AND DISPLAY APPARATUS USING THE SAME

(75) Inventor: Tetsuya Hamada, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/304,270

(22) PCT Filed: Feb. 6, 2007
(86) PCT No.: PCT/JP2007/051985

§ 371 Date: Dec. 11, 2008

(30) Foreign Application Priority Data
Jul. 24, 2006 (JP) 2006-201031

(51) Int. Cl. G09F 13/04; G09G 3/32

(52) U.S. Cl. 362/97.3; 345/82

(57) ABSTRACT

In a backlight device, two-channel LED modules including 4-light-emitting diodes connected in series and resistive elements connected in series to the respective LED module are provided. The resistor elements provide voltage drops to the corresponding LED modules, and thereby set output voltages to the respective LED modules in a predetermined voltage range.

### BACKGROUND OF THE INVENTION

1. Field of the Invention

The present invention relates to a backlight device, in particular, a backlight device having a light-emitting diode as a light source, and a display apparatus using the same.

2. Description of the Related Art

Recently, for example, a liquid crystal display apparatus has been widely used in liquid crystal televisions, monitors, mobile telephones, and the like as a flat panel display having advantages such as smaller thickness and lighter weight when compared with displays including conventional Braun tubes. Such liquid crystal display apparatuses include a backlight device emitting light and a liquid crystal panel displaying a desired image by functioning as a shutter with respect to light from a light source provided in the backlight device.

Furthermore, an edge-light type device or a direct-type device has been provided as the above-mentioned backlight device in which a linear light source composed of a cold cathode-ray tube or a hot cathode-ray tube is placed on the side of or below a liquid crystal panel. However, the cold cathode-ray tube and the like as described above contain mercury, so that it used to be difficult to recycle the cold cathode-ray tube. More recently, a backlight device using a light-emitting diode (LED) without using mercury as a light source has been proposed (see, for example, JP 2004-21147 A).

In the above-mentioned backlight device there is a demand for increasing the number of light-emitting diodes in order to address the enlargement of a screen and the increase in brightness in the liquid crystal display apparatus. Particularly, in a high-end product, such as a liquid crystal television capable of receiving digital broadcasting, it is vital to enhance brightness and the like by increasing the setting number of light-emitting diodes, and thus, there is a strong demand for increasing the setting number thereof.

However, in the above-mentioned conventional backlight device, the following problems arise: it is difficult to increase the setting number of light-emitting diodes, inconsistencies in brightness occur in light emitted outside from the backlight device when the setting number of light-emitting diodes is increased, the life of each light-emitting diode (backlight device) is shortened, and the like.

Specifically, in FIG. 7, a backlight device of a first conventional example includes an LED driving power supply portion 60a, and light-emitting diodes 63r, 63g, and 63b of red (R), green (G), and blue (B), supplied with power from the LED driving power supply portion 60a. The backlight device of the first conventional example also includes substrates 61, 62 on which, for example, four each of the light-emitting diodes 63r, 63g, and 63b are mounted respectively, and the light-emitting diodes 63r, 63g, and 63b on the substrates 61, 62 are connected in series for each corresponding color of RGB. That is, in the backlight device of the first conventional example, a total of eight of the light-emitting diodes 63r of red (R) are connected in series via a wire 60br, and the light-emitting diodes 63r are driven by being supplied with a constant current from an R-LED constant-current circuit 60ar provided in the LED driving power supply portion 60a.

Similarly, a total of eight of the light-emitting diodes 63g of green (G) are connected in series via a wire 60bg, and the light-emitting diodes 63g are driven by being supplied with a constant current from a G-LED constant-current circuit 60ag provided in the LED driving power supply portion 60a. Furthermore, a total of eight of the light-emitting diodes 63b of blue (B) are connected in series via a wire 60bb, and the light-emitting diodes 63b are driven by being supplied with a constant current from a B-LED constant-current circuit 60ab provided in the LED driving power supply portion 60a.

As described above, in the backlight device of the first conventional example, a plurality of the light-emitting diodes 63r, 63g, 63b are connected in series for each color of RGB. Therefore, when the setting number of the light-emitting diodes 63r, 63g, 63b of each color is increased, an output (driving) voltage to be output to the light-emitting diodes 63r, 63g, 63b of each color increases in proportion to the setting number, which causes a large increase in cost of the backlight device or remarkably increases a substrate size.

Specifically, in the case of using, for example, a power LED with a light emission amount enhanced substantially remarkably compared with that of a chip LED, the output voltage to the power LED per piece is about 2V to about 4V. Therefore, in the case of using ten or more of power LEDs in the backlight device of the first conventional example, it is necessary to provide a power supply circuit exceeding a predetermined voltage (for example, 50V) in the LED driving power supply portion 60a. Consequently, in the backlight device of the first conventional example, it is necessary to use an expensive electric component having an excellent insulation property in the LED driving power supply portion 60a, or the enlargement of the substrates 61, 62, etc. cannot be avoided so as to ensure a sufficient insulation space.

Furthermore, for example, in a backlight device for a liquid crystal display apparatus with at least 32-inch diagonal screen, at least 100 power LEDs are required to be set. Therefore, it is practically impossible to configure a backlight device capable of being designed for the liquid crystal display apparatus with at least 32-inch diagonal screen, using the backlight device of the first conventional example.

As shown in FIG. 8, in a backlight device of a second conventional example, an LED module of each color of RGB composed of four each of the light-emitting diodes 63r, 63g, 63b connected in series is configured on each of the substrates 61, 62. Then, the LED modules on two substrates 61, 62 are connected in parallel for each color of RGB. That is, in the backlight device of the second conventional example, for example, a red LED module on the substrate 61 and a red LED module on the substrate 62 are connected in parallel to the LED driving power supply portion 60a via the wire 60br, whereby a constant current is supplied from the R-LED constant-current circuit 60ar to each LED module. In the backlight device of the second conventional example, two LED modules are connected in parallel for each color of RGB, whereby the output voltage to each LED module can be set to be the above-mentioned predetermined voltage or less.

However, in light-emitting diodes, forward voltages Vf may vary remarkably on the product basis, so that each total value of the forward voltages Vf may vary largely in the above-mentioned two LED modules. Consequently, in two LED modules, a current may flow in a larger amount through one LED module, whereas a current may flow in a smaller amount through the other LED module. Thus, there arise problems in that inconsistencies in brightness occur in light emitted outside from the backlight device, the life of each light-emitting diode (backlight device) is shortened, and the like.

More specifically, in the LED module through which a current flows in a larger amount, the light amount increases compared with that in the LED module through which a current flows in a smaller amount, and the difference in light amount between the two LED modules increases, with the result that inconsistencies in brightness occur in light emitted outside. Furthermore, as a current flows through the light-emitting diode in a larger amount, the life of the light-emitting is shortened. Therefore, the life of each light-emitting diode is shortened in the LED module through which a current flows in a larger amount, compared with that of each light-emitting diode of the LED module through which a current flows in a smaller amount.

As described above, in the backlight device of the second conventional example, when the setting number of light-emitting diodes is increased, a current flowing through each of a plurality of LED modules connected in parallel becomes non-uniform, which may cause the above-mentioned inconsistencies in brightness or the decrease in life of the light-emitting diodes and the backlight device.

The following configuration may be considered: a constant-current circuit is set for each of the above-mentioned LED modules, and the respective LED modules are driven with a constant current independently while the output voltage to each LED module is limited to a predetermined voltage or less. However, in the case where the respective LED modules are driven independently, it is necessary to provide a constant-current circuit, a wiring structure, and the like for each LED module, which causes new problems: the configuration of a backlight device is complicated and enlarged, and a cost increases remarkably.

### SUMMARY OF THE INVENTION

In view of the above-mentioned problems, preferred embodiments of the present invention provide a backlight device with a long life that is capable of preventing the occurrence of inconsistencies in brightness even when the setting number of light-emitting diodes is increased, and a display apparatus using the backlight device.

A backlight device according to a preferred embodiment of the present invention includes M-channel (M is an integer of 2 or more) LED modules that are connected in parallel to each other and that include N (N is an integer of 1 or more) light-emitting diodes connected in series, and a voltage drop providing portion that is provided in at least one LED module among the M-channel LED modules and that provides a voltage drop to the LED module of a corresponding channel so that an output voltage to the LED module in which the voltage drop providing portion is provided is in a predetermined voltage range mutually with output voltages to the LED modules of the other respective channels.

The backlight device configured as described above includes N (N is an integer of 1 or more) light-emitting diodes, and M-channel (M is an integer of 2 or more) LED modules connected in parallel to each other. Furthermore, the voltage drop providing portion is provided in at least one LED module, and provides a voltage drop of the LED module of a corresponding channel so that the output voltage to the LED module is in a predetermined voltage range mutually with the output voltages to the LED modules of the other respective channels. Thus, a current flowing through each of the M-channel (M is an integer of 2 or more) LED modules can be made substantially uniform even when the setting number of the light-emitting diodes is increased. Consequently, a long-life backlight device that is capable of preventing the inconsistencies in brightness from occurring in light emitted to the outside from the backlight device can be configured.

Furthermore, in the above backlight device, it is preferred that, based on forward voltage—forward current characteristics of the light-emitting diodes included in the LED module of the corresponding channel, a value of a voltage drop provided to the LED module is determined in the voltage drop providing portion.

In this case, the influence of the variation in light-emitting diode products can be minimized, and a long-life backlight device can be easily configured while the occurrence of inconsistencies in brightness is easily prevented.

Furthermore, in the backlight device, the numbers of the light-emitting diodes connected in series may be the same in the respective M-channel LED modules.

In this case, the adjustment of an output voltage to each LED module can be easily performed, and an increase in the number of different types of components in the backlight device can be minimized.

Furthermore, in the above-mentioned backlight device, resistor elements connected in series with respect to the light-emitting diodes included in the LED module of the corresponding channel may be used in the voltage drop providing portion. In this case, the configuration of the voltage drop providing portion can be easily simplified.

Furthermore, in the above-mentioned backlight device, the voltage drop providing portion may include a variable resisting portion connected in series with respect to the light-emitting diodes included in the LED module of the corresponding channel. In this case, the output voltage to the LED module of the channel in which the voltage drop providing portion is provided can be easily adjusted.

Furthermore, in the above-mentioned backlight device, a plurality of short bars may be used in the variable resisting portion. In this case, the configuration of the variable resisting portion can be simplified, and variable resisting portions with the same configuration can be set with respect to all the M-channel LED modules, whereby the assembly operation of the backlight device can be simplified while the increase in the number of component kinds of the backlight device is prevented.

Furthermore, in the above-mentioned backlight device, the variable resisting portion may include a variable resistor and a control portion that controls a resistance of the variable resistor. In this case, the adjustment of an output voltage to the LED module of the channel in which the voltage drop providing portion is provided can be easily and automatically performed.

Furthermore, in the above-mentioned backlight device, it is preferred that the M-channel LED modules are provided for each color of RGB of red (R), green (G), and blue (B). In this case, the color purity of each light-emission color of red, green, and blue can be enhanced while the adjustment operation of an output voltage in the M-channel LED modules can be performed easily, and a backlight device of more excellent light-emission quality can be configured easily.

Furthermore, in the above-mentioned backlight device, the light-emitting diodes have forward voltages that are initially measured and are distributed to any of at least two ranks based on resulting measurements, and a plurality of light-emitting diodes distributed to the same rank are connected in series in at least one LED module among the M-channel LED modules. In this case, in a plurality of light-emitting diodes included in at least one LED module, the forward voltages are aligned substantially, so that the value of a voltage drop by the voltage drop providing portion can be easily determined. Furthermore, it is preferred to use each of the plurality of light-emitting diodes distributed to the same rank with respect to each LED module of all the channels, because the adjustment operation of an output voltage between channels can be performed easily.

Furthermore, the display apparatus according to a preferred embodiment of the present invention includes a display portion, wherein the display portion is irradiated with light from any of the above-mentioned backlight devices. In the display apparatus configured as described above, even when the setting number of the light-emitting diodes is increased, the display portion is irradiated with light from the backlight device capable of preventing the occurrence of inconsistencies in brightness. Therefore, the liquid crystal display apparatus that is excellent in display performance can be easily configured, even if the increase in brightness and the enlargement of a screen of the display portion are performed. Furthermore, the long-life backlight device is used, so that the display apparatus with the service of life enhanced and with a long maintenance period can be easily configured.

According to a preferred embodiment of the present invention, a backlight device with a long life that is capable of preventing the occurrence of inconsistencies in brightness even when the setting number of light-emitting diodes is increased, and a display apparatus using the backlight device can be provided.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a view illustrating a backlight device and a liquid crystal display apparatus according to a first preferred embodiment of the present invention.

FIG. 2 is a plan view showing a configuration of main components of a backlight device according to a first preferred embodiment of the present invention.

FIG. 3 is a diagram illustrating an exemplary configuration of light-emitting diodes shown in FIG. 2 and a driving circuit thereof.

FIG. 4 is a graph showing a specific example of Vf-If characteristics of the light-emitting diodes shown in FIG. 2.

FIG. 5 is a diagram illustrating configurations of main components of a backlight device according to a second preferred embodiment of the present invention.

FIG. 6 is a diagram illustrating configurations of main components of a backlight device according to a third preferred embodiment of the present invention.

FIG. 7 is a circuit diagram showing a configuration of a lighting circuit of light-emitting diodes in a backlight device of a first conventional example.

FIG. 8 is a circuit diagram showing a configuration of a lighting circuit of light-emitting diodes in a backlight device of a second conventional example.

### DESCRIPTION OF THE PREFERRED EMBODIMENTS

Hereinafter, a backlight device and a display apparatus using the backlight device according to preferred embodiments of the present invention will be described with reference to the drawings. In the following description, a case where the present invention is applied to a transmission-type liquid crystal display apparatus will be illustrated.

### First Preferred Embodiment

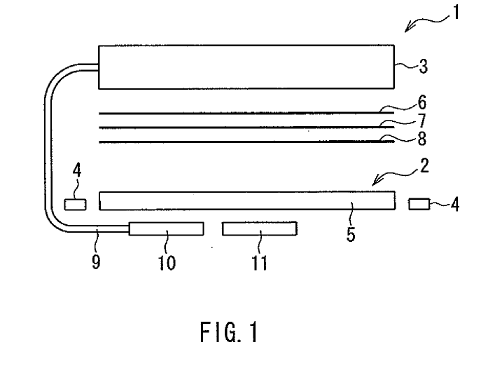

FIG. 1 is a view illustrating a backlight device and a liquid crystal display apparatus according to a first preferred embodiment of the present invention. In FIG. 1, in the present preferred embodiment, a backlight device 2 of the present invention and a liquid crystal panel 3 as a display portion that is irradiated with light from the backlight device 2 are provided, and the backlight device 2 and the liquid crystal panel 3 are integrated as a transmission-type liquid crystal display apparatus 1.

The backlight device 2 is an edge-light type, and includes a plurality of light-emitting diodes 4 as a light source and a light-guiding plate 5 to which light is guided from each of the plurality of light-emitting diodes 4. Furthermore, in the backlight device 2, as illustrated in FIG. 1, the plurality of light-emitting diodes 4 are placed in either one of setting regions of the light-emitting diodes 4 on a left side and a right side of FIG. 1 with respect to the light-guiding plate 5. Then, the backlight device 2 irradiates the liquid crystal panel 3 side with illumination light in a plane shape from the light-guiding plate 5.

The plurality of light-emitting diodes 4 include red, green, and blue light-emitting diodes that respectively emit red (R), green (G), and blue (B) light, and a 2-channel LED module is provided for each color of RGB (described in detail later).

The light-guiding plate 5 is preferably made of, for example, a synthetic resin such as a transparent acrylic resin. Furthermore, as illustrated in FIG. 1, a plate having a cross-section with a rectangular or substantially rectangular shape is used as the light-guiding plate 5, and light is incident upon each of right and left side surfaces in FIG. 1 from the light-emitting diodes 4 placed in the corresponding setting region. Then, in the light-guiding plate 5, illumination light is output toward the liquid crystal panel 3 from a light-emitting plane placed opposed to a diffusion sheet 8 described later.

Specifically, the respective right and left light-emitting diodes 4 and the light-guiding plate 5 are housed in a housing (not shown), and light from each light-emitting diode 4 is efficiently guided to the inside of the light-guiding plate 5 directly or indirectly via a reflector from the corresponding left side surface or right side surface while the light leakage to the outside is minimized. Consequently, in the backlight device 2, the light use efficiency of each light-emitting diode 4 can be enhanced easily, and the brightness of the above illumination light can be increased easily.

Furthermore, in the liquid crystal display apparatus 1, for example, a polarizing sheet 6, a prism sheet 7, and the diffusion sheet 8 are placed between the liquid crystal panel 3 and the light-guiding plate 5, and the increase in brightness of the illumination light from the backlight device 2 and the like are performed appropriately by the optical sheets, whereby the display performance of the liquid crystal panel 3 is enhanced.

Furthermore, the liquid crystal display apparatus 1 is configured in such a manner that a liquid crystal layer (not shown) included in the liquid crystal panel 3 is connected to a driving control circuit 10 via a flexible printed circuit (FPC) 9, and the driving control circuit 10 is capable of driving the above-mentioned liquid crystal layer on a pixel-by-pixel basis. Furthermore, the driving control circuit 10 is attached in the vicinity of, for example, the left setting region of the light-emitting diodes 4 on a back side of the light-guiding plate 5 of the backlight device 2. Furthermore, a lighting driving circuit 11 is set as a driving circuit that lights-up the plurality of light-emitting diodes 4 in the vicinity of the driving control circuit 10.

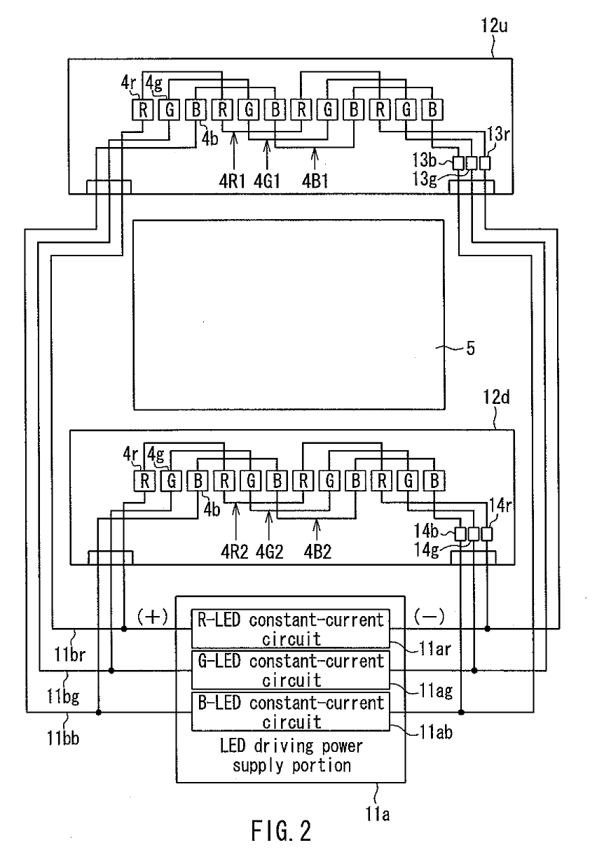

Hereinafter, referring to FIG. 2, the above-mentioned LED module including the plurality of light-emitting diodes 4 will be described specifically.

As shown in FIG. 2, the plurality of light-emitting diodes 4 include light-emitting diodes 4r, 4g, 4b emitting light of each color of RGB as described above, and the light-guiding plate 5 mixes the guided light of each color of RGB into white light and outputs the white light as illumination light from the above-mentioned light-emitting plane. Thus, in the backlight device 2, the emission quality of illumination light is enhanced, and illumination light suitable for a full-color image is allowed to be incident upon the liquid crystal panel 3, whereby the display quality of the liquid crystal panel 3 can be easily enhanced.

Furthermore, in the plurality of light-emitting diodes 4, the setting number, kind, size, and the like of the respective light-emitting diodes 4r, 4g, 4b of RGB are selected depending upon the size of the liquid crystal panel 3 and the display performance such as brightness and display quality required by the liquid crystal panel 3. Specifically, for each light-emitting diode 4, for example, a power LED with a power consumption of about 1 W or a chip LED with a power consumption of about 70 mW is appropriately used.

Furthermore, as illustrated in FIG. 2, the light-emitting diodes 4r, 4g, 4b of each color of RGB are connected in series on substrates 12u, 12d, and corresponding LED modules 4R1, 4G1, 4B1, 4R2, 4G2, 4B2 of RGB are configured on the corresponding substrates 12u and 12d. More specifically, 2-channel LED modules 4R1, 4G1, 4B1, 4R2, 4G2, 4B2 are provided for each color of RGB.

Furthermore, resistor elements 13r, 13g, 13b are mounted as voltage drop providing portions on the substrate 12u, and are connected in series respectively to the light-emitting diodes 4r, 4g, 4b included in the LED modules 4R1, 4G1, 4B1. Similarly, resistor elements 14r, 14g, 14b are mounted as voltage drop providing portions on the substrate 12d, and are connected in series respectively to the light-emitting diodes 4r, 4g, 4b included in the LED modules 4R2, 4G2, 4B2.

The substrates 12u and 12d are placed respectively on an upper side and a lower side in a vertical direction in which gravity is applied during the use of the liquid crystal display apparatus 1, and are placed on an outer peripheral side of a corresponding side surface so that the light from light-emitting diodes 4 is guided to the side surfaces (the left side surface and the right side surface in FIG. 1) opposed to each other of the light-guiding plate 5.

Furthermore, the plurality of light-emitting diodes 4 are supplied with power from an LED driving power supply portion 11a included in the lighting driving circuit 11 for each color of RGB, and thus, driven by constant current driving. Specifically, the LED module 4R1 and the resistor element 13r, and the LED module 4R2 and the resistor element 14r are connected in parallel via a wire 11br. Then, each light-emitting diode 4r of the LED modules 4R1, 4R2 is driven by being supplied with a constant current from an R-LED constant-current circuit liar provided in the LED driving power supply portion 11a.

Similarly, the LED module 4G1 and the resistor element 13g, and the LED module 4G2 and the resistor element 14g are connected in parallel via a wire 11bg. Then, each light-emitting diode 4g of the LED modules 4G1, 4G2 is driven by being supplied with a constant current from a G-LED constant-current circuit 11ag provided in the LED driving power supply portion 11a.

Similarly, the LED module 4B1 and the resistor element 13b, and the LED module 4B2 and the resistor element 14b are connected in parallel via a wire 11bb. Then, each light-emitting diode 4b of the LED modules 4B1, 4B2 is driven by being supplied with a constant current from a B-LED constant-current circuit 11ab provided in the LED driving power supply portion 11a.

Furthermore, in the backlight device 2, 2-channel LED modules of each color of RGB, e.g., 2-channel red LED modules 4R1, 4R2 are connected in parallel, whereby the output voltage to each of the LED modules 4R1, 4R2 is limited to a predetermined voltage (for example, 50V) or less. Thus, the lighting driving circuit 11 can be configured at a low cost without using components which have high dielectric strength and are expensive, as electric components used for the lighting driving circuit 11 including the LED driving power supply portion 11a. Furthermore, the substrates 12u and 12d for mounting the compact light-emitting diodes 4 can be used.

Furthermore, the voltage drop providing portions (that is, the resistor elements 13r, 13g, 13b, 14r, 14g, 14b) for each channel are provided on the respective substrates 12u and 12d, whereby the difference between the output voltages to, for example, the LED modules 4R1, 4R2 connected in parallel, is set to be in a predetermined voltage range in the backlight device 2.

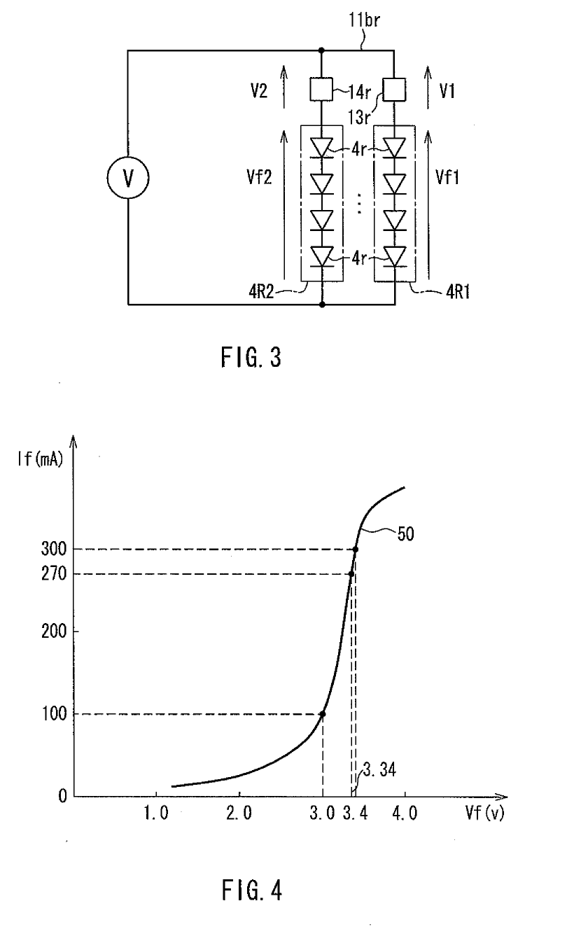

Hereinafter, the above-mentioned voltage drop providing portions will be described specifically with reference to FIGS. 3 and 4. In the following description, the red LED modules 4R1, 4R2 and the resistor elements 13r, 14r will be illustrated. Furthermore, the case will be described where values of about 3.4V and about 300 mA, for example, are selected respectively as a forward voltage Vf0 and a forward current If0 of standard driving conditions in each light-emitting diode 4r of the LED modules 4R1, 4R2.

In FIG. 3, the total value of the forward voltages of the light-emitting diodes 4r included in the LED module 4R1 is represented by Vf1. Furthermore, V1 shown in FIG. 3 is a value of a voltage drop occurring in the resistor element 13r, when each light-emitting diode 4r of the LED module 4R1 is driven under the above-mentioned standard driving conditions. More specifically, when each light-emitting diode 4r of the LED module 4R1 is driven under the standard driving conditions, a current of about 300 mA flows through the resistor element 13r. Herein, assuming that the resistance of the resistor element 13r is 13r1, a value V1 (=0.3×13r1) of a voltage drop obtained by the product of the forward current If0 and the resistance 13r1 is generated in the resistor element 13r. Consequently, the LED module 4R1 is provided with the value V1 of a voltage drop from the resistor element 13r, and an output voltage VR1 to the LED module 4R1 when driven under the standard driving conditions becomes a value obtained by adding the value V1 of a voltage drop to the total value Vf1 of the forward voltages.

On the other hand, the total value of the forward voltages of the light-emitting diodes 4r included in the LED module 4R2 is represented by Vf2, and when each light-emitting diode 4r of the LED module 4R2 is driven under the standard driving conditions, a current of about 300 mA flows through the resistor element 14r. Herein, assuming that the resistance of the resistor element 14r is 14r1, a value V2 (=0.3×14r1) of a voltage drop obtained by the product of the forward current If0 and the resistance 14r1 is generated in the resistor element 14r. Consequently, the LED module 4R2 is provided with a value V2 of a voltage drop from the resistor element 14r, and an output voltage VR2 to the LED module 4R2 when driven under the standard driving conditions becomes a value obtained by adding the value V2 of a voltage drop to the total value Vf2 of the forward voltages.

Furthermore, in the resistor elements 13r, 14r, the values V1, V2 of voltage drops are determined so that the voltage difference between the output voltage VR1 to the LED module 4R1 and the output voltage VR2 to the LED module 4R2 falls in the predetermined voltage range. Furthermore, in the resistor elements 13r, 14r, the resistances 13r1, 14r1 are determined using the values V1, V2 of voltage drops and the forward current If0 of the standard driving conditions.

More specifically, in the case where the total values Vf1 and Vf2 of forward voltages when a current of about 300 mA flows through the LED modules 4R1 and 4R2 are about 13.6V and about 13.36V, respectively, for example, the value V1 of a voltage drop from the resistor element 13r is set to be about 0V (that is, the resistor element 13r is about 0Ψ, so that the setting of the resistor element 13r can be omitted). Furthermore, by setting the value V2 of a voltage drop from the resistor element 14r to be about 0.24V (=about 13.6V−about 13.36V), the output voltage VR1 and the output voltage VR2 can be set to be the same value.

As an alternative to the above description, the resistor elements 13r, 14r also can be selected, for example, so that the values V1 and V2 of voltage drops become about 1V and about 1.24V, respectively. However, it is preferred that the output voltages VR1, VR2 are matched with a higher forward voltage among the total values Vf1 and Vf2 of the forward voltages, and the value of a voltage drop in the corresponding resistor element is set to be about 0V, because the setting of the resistor element can be omitted, and the power consumption of the LED modules 4R1, 4R2 (backlight device 2) can be minimized.

Furthermore, the values V1, V2 of voltage drops are determined based on the characteristics of the forward voltage Vf—forward current If of the light-emitting diodes 4r illustrated by a curve 50 in FIG. 4. More specifically, if the allowable light amount range is set to be, for example, about 10% with respect to the light amount of the light-emitting diodes 4r when driven under the standard driving conditions, the light amount and the current flowing through the light-emitting diodes 4r become substantially proportional to each other, so that the allowable current value becomes about 270 mA (=about 300 mA×about 0.9 mA).

Furthermore, as the allowable forward voltage Vf of the light-emitting diode 4r, about 3.34V is obtained with reference to the curve 50 based on about 270 mA. Thus, an allowable output voltage ΔV for each light-emitting diode 4r becomes about 0.06V (=about 3.4V−about 3.34V) or less, and the above-mentioned predetermined voltage range of the LED modules 4R1 and 4R2 in which four each of the light-emitting diodes 4r are connected in series becomes about 0.24V (=about 0.06V×about 4V) or less. Then, in the resistor elements 13r, 14r, the values V1, V2 of voltage drops are determined so that the voltage difference between the output voltages VR1 and VR2 becomes about 0.24V or less.

As an alternative to the above description, the voltage difference (predetermined voltage range) of the output voltages VR1, VR2 is determined based on the above-mentioned predetermined voltage regarding the output voltage to each of the LED modules 4R1, 4R2, and the values V1, V2 of voltage drops at the resistor elements 13r, 14r also can be determined. Specifically, the setting number of the light-emitting diodes in each of the LED modules 4R1, 4R2, at which the output voltage can be set to be a predetermined voltage or less, is obtained by dividing the predetermined voltage of about 50V by the forward voltage Vf of about 3.4V under the standard driving conditions. More specifically, the setting number becomes about 14 (≦about 14.7=about 50/about 3.4). Then, about 0.84V is obtained by multiplying the setting number of about 14 by the output voltage ΔV of about 0.06V and about 0.84V or less is set to be in the predetermined voltage range, and the values V1, V2 of voltage drops at the resistor elements 13r, 14r also can be selected.

In the present preferred embodiment configured as described above, 2-channel LED modules 4R1, 4G1, 4B1, 4R2, 4G2, and 4B2 are provided for each color of RGB and connected in parallel to each other. Furthermore, the difference between the output voltages to the LED modules 4R1, 4R2 is set to be in the predetermined voltage range by the resistor elements (voltage drop providing portions) 13r, 14r connected in series respectively to the LED modules 4R1, 4R2. Furthermore, the different between the output voltages to the LED modules 4G1, 4G2 is set to be in the predetermined voltage range by the resistor elements (voltage drop providing portions) 13g, 14g connected in series respectively to the LED modules 4G1, 4G2, and the different between the output voltages to the LED modules 4B1, 4B2 is set to be in the predetermined voltage range by the resistor elements (voltage drop providing portions) 13b, 14b connected in series respectively to the LED modules 4B1, 4B2. Because of this, even when the setting number of the light-emitting diodes 4 is increased, currents flowing through the 2-channel LED modules 4R1, 4R2, the 2-channel LED modules 4G1, 4G2, the 2-channel LED modules 4B1, 4B2, respectively can be made substantially uniform, unlike the above-mentioned second conventional example.

Thus, in the present preferred embodiment, even when the setting number of the light-emitting diodes 4 is increased, the light amounts of the respective LED modules of a plurality of channels in each color of RGB can be made substantially the same, unlike the second conventional example. Consequently, in the illumination light emitted outside from the backlight device 2, the overall inconsistencies in brightness can be prevented from occurring. Furthermore, even when the setting number of the light-emitting diodes 4 is increased, the liquid crystal display apparatus 1 excellent in display performance can be configured easily in the present preferred embodiment, even if the increase in brightness and the enlargement of a screen of the liquid crystal panel (display portion) 3 are performed, by using the backlight device 2 in which the inconsistencies in brightness is prevented from occurring.

The currents flowing through the LED modules 4R1, 4R2, the LED modules 4G1, 4G2, and the LED modules 4B1, 4B2 respectively can be made substantially uniform. Therefore, unlike the second conventional example, the decrease in life of the light-emitting diodes caused by the non-uniformity of supply currents can be prevented in the light-emitting diodes 4 that are driven with a constant current. Thus, the service life can be enhanced by prolonging the lives of the backlight device and the liquid crystal display apparatus.

Furthermore, in the present preferred embodiment, the values of voltage drops in the above-mentioned voltage drop providing portions are determined based on the characteristics of the forward voltage Vf—forward current If illustrated in FIG. 4, so that the influence of the variation in light-emitting diode products can be minimized. Consequently, a long-life backlight device and liquid crystal display apparatus can be configured easily while the occurrence of inconsistencies in brightness is prevented easily.

In the above description, the case where the resistor elements 13r, 13g, 13b are mounted on the substrate 12u, and the resistor elements 14r, 14g, 14b are mounted on the substrate 12d has been illustrated. However, the present preferred embodiment is not limited thereto, and these resistor elements may be set on the LED driving power supply portion 11a (lighting driving circuit 11) side.

### Second Preferred Embodiment

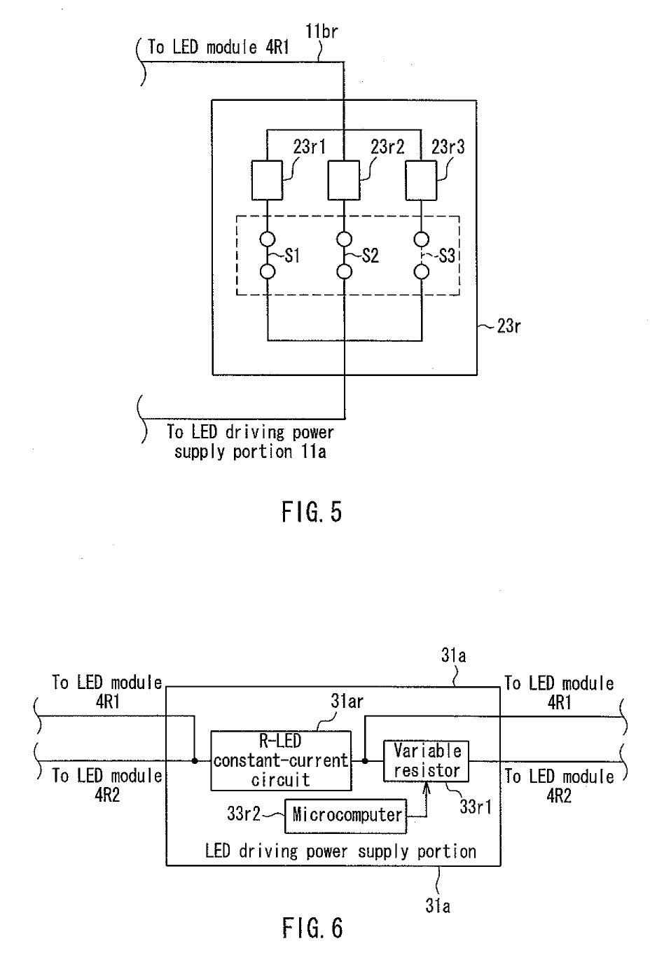

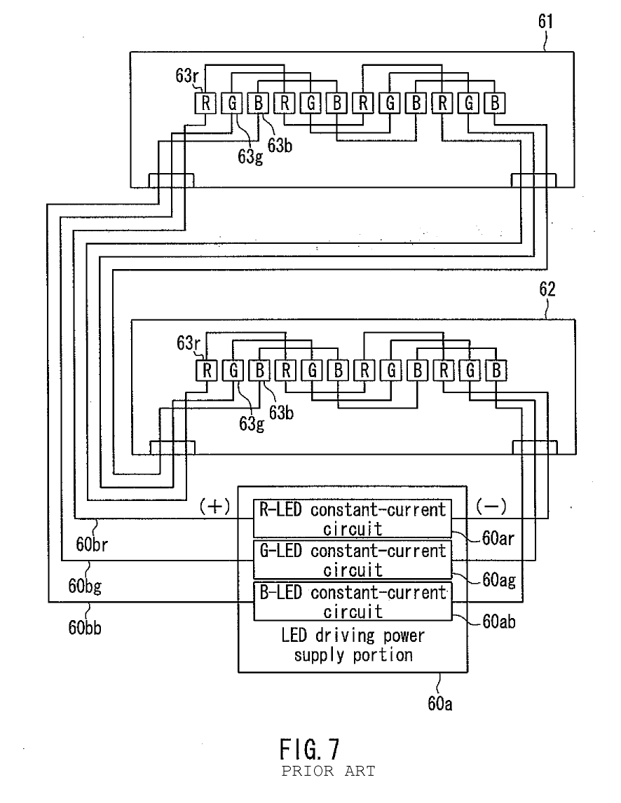

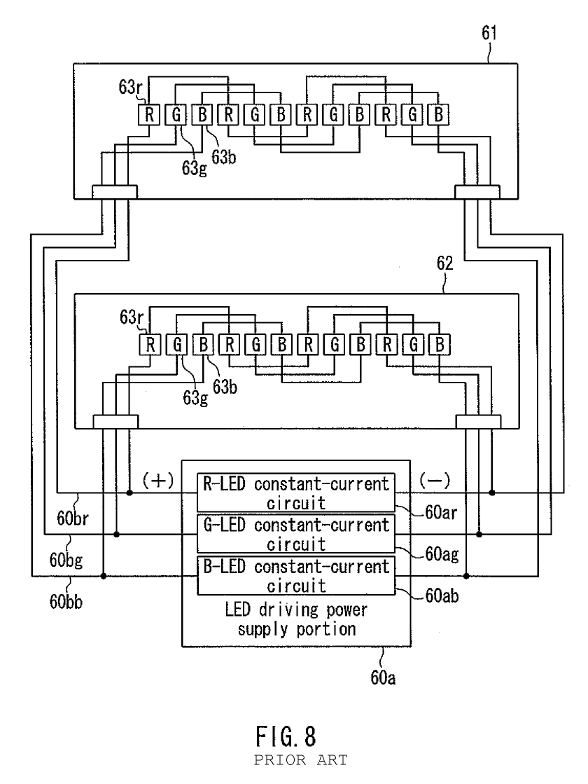

FIG. 5 is a diagram illustrating configurations of main portions of a backlight device according to second preferred embodiment of the present invention. In the figure, the main difference between the present preferred embodiment and the first preferred embodiment lies in that a variable resisting portion having a plurality of short bars is used in place of the resistor elements. Components similar to those in the first preferred embodiment are denoted with the same reference numerals as those therein, and the repeated description will be omitted.

More specifically, as illustrated in FIG. 5, in the present preferred embodiment, a variable resisting portion 23r is mounted on the substrate 12u (FIG. 2) as a voltage drop providing portion. The variable resisting portion 23r has one end side connected in series to the light-emitting diodes 4r of the LED module 4R1, and has resistor elements 23r1, 23r2, and 23r3 connected in parallel to each other.

Furthermore, in the variable resisting portion 23r, three terminal portions with short bars S1, S2, S3 being attachable/detachable are provided between each of the other end sides of the resistor elements 23r1, 23r2, 23r3 and the R-LED constant-current circuit liar (FIG. 2) in the LED driving power supply portion 11a. Then, in the variable resisting portion 23r, each attachment or detachment of the short bars S1, S2, S3 is selected, whereby the resistance of the variable resisting portion 23r is changed to alter the value of a voltage drop to be provided to the LED module 4R1.

That is, as shown in FIG. 5, among the short bars S1, S2, S3, the short bars S1, S2 are attached to corresponding terminal portions, and the short bar S3 is detached from a corresponding terminal portion. Thus, the voltage drops by the resistor elements 23r1, 23r2 are provided to the LED module 4R1, and the voltage difference between the output voltage VR1 to the LED module 4R1 and the output voltage VR2 to the LED module 4R2 can be set to be in the predetermined voltage range.

In the present preferred embodiment configured as described above, the variable resisting portion (voltage drop providing portion) 23r provides a voltage drop to the corresponding LED module 4R1, so that the effect similar to that of the first preferred embodiment can be exhibited. Furthermore, since the short bars S1, S2, S3 are used, the configuration of the variable resisting portion can be simplified, compared with the case using a variable resistor such as a varistor that changes a resistance manually. Furthermore, variable resisting portions with the same configuration can be set with respect to all the LED modules, whereby the assembly operation of the backlight device 2 can be simplified while the increase in the number of component kinds of the backlight device 2 is prevented.

As an alternative to the above description, the variable resisting portion 23r may be set on the LED driving power supply portion 11a (lighting driving circuit 11) side in the same way as in the first preferred embodiment. Furthermore, as an alternative to the above description, a variable resisting portion also can be used, in which a plurality of resistor elements are connected in series and short bars are connected in parallel to each resistor element.

### Third Preferred Embodiment

FIG. 6 is a diagram illustrating the configurations of main portions of a backlight device according to a third preferred embodiment of the present invention. In the diagram, the main difference between the present preferred embodiment and the first preferred embodiment lies in that a variable resistor and a microcomputer driving the variable resistor are provided in place of the resistive element. The same components as those in the first preferred embodiment are denoted with the same reference numerals as those therein, and the repeated description thereof will be omitted.

More specifically, as illustrated in FIG. 6, an LED driving power supply portion 31a of the present preferred embodiment includes an R-LED constant-current circuit 31ar, a variable resistor 33r1 connected in series to the R-LED constant-current circuit 31ar, and a microcomputer 33r2 as a control portion controlling a resistance of the variable resistor 33r1. One end side of the R-LED constant-current circuit 31ar is connected to each one end side of LED modules 4R1, 4R2. Furthermore, the other end side of the R-LED constant-current circuit 31ar is connected to the other end side of the LED module 4R1 and the other end side of the LED module 4R2 via the variable resistor 33r1.

Furthermore, the variable resistor 33r1 and the microcomputer 33r2 constitute the variable resisting portion as the voltage drop providing portion, and the microcomputer 33r2 changes a resistance of the variable resistor 33r1 with respect to the LED module 4R2 connected in series to the variable resistor 33r1, whereby an appropriate voltage drop is provided to the LED module 4R2. Then, a voltage difference between an output voltage VR1 to the LED module 4R1 and an output voltage VR2 to the LED module 4R2 is set to be in the predetermined voltage range.

In the present preferred embodiment configured as described above, since the microcomputer 33r2 appropriately changes the resistance of the variable resistor 33r1, thereby providing a voltage drop to the corresponding LED module 4R2. Therefore, the effect similar to that of the first preferred embodiment can be exhibited. In the present preferred embodiment, because the microcomputer 33r2 and the variable resistor 33r1 are used for the variable resisting portion, the adjustment of the output voltage VR2 to the corresponding LED module 4R2, and the adjustment of the output voltage VR2 and the output voltage VR1 to the LED module 4R1 can be performed more easily and automatically.

In the above description, although the configuration has been described in which the variable resistor 33r1 is connected in series only to the LED module 4R2 of one of two channels and controlled using the microcomputer 33r2, the present preferred embodiment is not limited thereto. The variable resistor may be connected in series respectively to both the two channels, and independent microcomputer control may be performed, for example, with a single microcomputer.

As an alternative to the above description, a variable resisting portion using the variable resistor 33r1 and the microcomputer 33r2 may be placed on the corresponding substrate side. Also, another data processing apparatus such as a digital signal processor (DSP) and a peripheral interface controller (PIC) can be used as the control portion of the variable resistor, in place of the microcomputer.

As an alternative to the above description, the control portion also can change the value of the variable resistor depending upon the aged degradation in light-emitting diodes. Specifically, data representing a change in a light amount involved in the aged degradation in each light-emitting diode of the LED modules is stored in a memory of a microcomputer. Then, the control portion appropriately refers to the above-mentioned data, thereby changing a value of the variable resistor so that the light amounts of the LED modules become the same. This can minimize the decrease in performance such as the decrease in a light amount caused by the aged degradation in light-emitting diodes.

Furthermore, the control portion also can control a value of the variable resistor to adjust a current value, a light amount, and the like in real time, depending upon the change in environment of the LED modules. Specifically, for example, a temperature sensor detecting the ambient temperature of an LED module is provided, and the control portion grasps the above ambient temperature based on the sensing results of the temperature sensor to change the value of the variable resistor, whereby the light amount and the like of the LED module can be adjusted optimally.

The above preferred embodiments are shown merely for an illustrative purpose and are not limiting. The technical range of the present invention is defined by the claims, and all the changes within a range equivalent to the configuration recited in the claims also are included in the technical range of the present invention.

For example, in the above description, the case where preferred embodiments of the present invention are applied to the transmission-type liquid crystal display apparatus has been described. However, the backlight device of the present invention is not limited thereto, and the backlight device can be applied to various kinds of display apparatus having a non-light-emission type display portion that displays information such as an image and a character using light from a light source. Specifically, the backlight device of preferred embodiments of the present invention can be used preferably for a semi-transmission type or reflection type liquid crystal display apparatus or a projection type display apparatus such as a rear projection.

Furthermore, as an alternative to the above description, preferred embodiments of the present invention can be used preferably as a film viewer that irradiates an X-ray photograph with light, a light box that irradiates a negative or the like with light to make it easy to recognize the negative visually, or a backlight device of a light-emitting device for lighting up a signboard or advertisement set on a wall surface in a station premise.

Furthermore, in the above description, the case has been described in which two LED modules respectively including four light-emitting diodes connected in series for each color of RGB are connected in parallel to each other to configure a backlight device having 2-channel LED modules. However, the number of channels of the LED modules and the setting number of light-emitting diodes in the LED modules are not limited to the above, as long as the voltage drop providing portion provides a voltage drop to at least one LED module of a plurality of channels connected in parallel to each other, whereby the output voltages to the respective LED modules of a plurality of channels are set to be in the predetermine voltage range. That is, preferred embodiments of the present invention only need to include M-channel (M is an integer of 2 or more) LED modules that are connected in parallel to each other and include N (N is an integer of 1 or more) light-emitting diodes connected in series.

It is preferred that the number of light-emitting diodes connected in series is set to be the same in the respective LED modules as in each of the above-described preferred embodiments, because the adjustment of an output voltage to each LED module can be easily performed. This also is preferred since the number of components of the backlight device can be minimized. Furthermore, this also is preferred because the value of a voltage drop is not required to be increased more than necessary in the voltage drop providing portion and the power consumption of the backlight device can be suppressed.

Furthermore, in the above description, although the case where preferred embodiments of the present invention are applied to the edge-light type backlight device has been described, the present invention is not limited thereto. The present invention also can be applied to a direct-type backlight device, in which a plurality of light-emitting diodes are set on a lower side (non-display surface side) of the display portion (liquid crystal panel). In the case of applying the present invention to such a direct-type backlight device, for example, the above-mentioned M-channel LED modules may be placed respectively so as to be parallel to the vertical direction or the horizontal direction of the display portion.

Furthermore, in the above description, although the case using red, green, and blue light-emitting diodes emitting color light corresponding to RGB has been described, preferred embodiments of the present invention are not limited thereto, and the present invention also can be applied to a backlight device including only white light-emitting diodes emitting white light as a light source. The present invention also can be applied to a backlight device using light-emitting diodes of at least two colors (for example, yellow and blue) whose light-emission colors are different and which can be mixed into white light.

It is preferred to use light-emitting diodes of red, green, and blue as in the above preferred embodiments, because the color purity of each light-emission color of red, green, and blue included in illumination light can be enhanced, the light-emission quality of the backlight device can be enhanced easily, and a display apparatus with a display quality (display performance) enhanced can be configured easily. Furthermore, this also is preferred because the adjustment operation of an output voltage in M-channel LED modules of each color of RGB can be performed easily.

Furthermore, as an alternative to the above description, in at least one LED module among the M-channel LED modules, a plurality of light-emitting diodes in which forward voltages are distributed previously to the same rank may be used. More specifically, each of a plurality of light-emitting diodes is lit at the same current value, whereby the forward voltages of the corresponding light-emitting diodes are measured, and the light-emitting diodes are previously distributed to any of at least two ranks based on the measurement results. Then, the light-emitting diodes at the same rank among the distributed plurality of light-emitting diodes are connected in series, whereby an LED module may be configured.

As described above, in the case where the LED module is composed of only the light-emitting diodes at the same rank, the forward voltages of a plurality of light-emitting diodes included in the LED module are aligned substantially, so that the value of a voltage drop by the voltage drop providing portion can be easily determined.

It is preferred to use each of the plurality of light-emitting diodes distributed to the same rank with respect to each LED module of all the channels, because the adjustment operation of an output voltage between channels can be easily performed.

Furthermore, the above also is preferred because an LED module can be configured using the light-emitting diodes distributed to the same rank so that the output voltage to the LED module of each channel is decreased, so that the power consumption of the LED module (backlight device) and the display apparatus can be easily reduced.

Furthermore in the above description, although the case using the variable resisting portion including resistive elements, short bars, or variable resistors has been described, the voltage drop providing portion of preferred embodiments of the present invention is not limited as long as a voltage drop can be provided to the LED module, and electric components such as a diode and a transistor also can be used in the voltage drop providing portion.

It is preferred to use the resistor elements as in the first preferred embodiment, because the voltage drop providing portion that is easy to handle can be configured while the configuration thereof is simplified. Furthermore, it is preferred to use the variable resisting portion as in the second and third preferred embodiments, because the adjustment of an output voltage to an LED module of a channel in which the variable resisting portion is set can be performed more easily, and the adjustment operation of an output voltage to the other channel can be performed more easily.

A backlight device according to a preferred embodiment of the present invention and a display apparatus using the backlight device can be increased in life while the inconsistencies in brightness are prevented from occurring even when the setting number of light-emitting diodes is increased. This is effective for the backlight device that is capable of irradiating a display portion having a large screen with light having high brightness and that is enhanced in a service life, and the display apparatus using the backlight device.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11. A backlight device, comprising:
M-channel LED modules that are connected in parallel to each other and that include N light-emitting diodes connected in series; and
a voltage drop providing portion that is provided in at least one LED module among the M-channel LED modules and that provides the LED module of a corresponding channel with a voltage drop so that an output voltage to the LED module in which the voltage drop providing portion is provided is in a predetermined voltage range mutually with output voltages to the LED modules of the other respective channels; wherein
M is an integer equal to 2 or more, and N is an integer equal to 1 or more.

12. The backlight device according to claim 11, wherein a value of a voltage drop provided to the LED module is determined in the voltage drop providing portion based on forward voltage—forward current characteristics of the light-emitting diodes included in the LED module of the corresponding channel.

13. The backlight device according to claim 11, wherein a number of the N light-emitting diodes connected in series is the same as a number of the respective M-channel LED modules.

14. The backlight device according to claim 11, wherein resistor elements connected in series with respect to the light-emitting diodes included in the LED module of the corresponding channel are used in the voltage drop providing portion.

15. The backlight device according to claim 11, wherein the voltage drop providing portion includes a variable resisting portion connected in series with respect to the light-emitting diodes included in the LED module of the corresponding channel.

16. The backlight device according to claim 15, wherein the variable resisting portion includes a plurality of short bars.

17. The backlight device according to claim 15, wherein the variable resisting portion includes a variable resistor and a control portion arranged to control a resistance of the variable resistor.

18. The backlight device according to claim 11, wherein the M-channel LED modules are provided for each of a red color, a green color, and a blue color.

19. The backlight device according to claim 11, wherein the light-emitting diodes have measured forward voltages and are distributed in any of at least two ranks based on the measured forward voltages; and
a plurality of light-emitting diodes distributed to the same rank are connected in series in at least one LED module among the M-channel LED modules.

20. A display apparatus comprising a display portion, wherein the display portion is irradiated with light from the backlight device according to claim 11.
